(19) United States
(12) Patent Application Publication
(10) Pub. No.: US 2003/0226981 A1
(43) Pub. Date: Dec. 11, 2003

(54) Beta radiation shielding system

(76) Inventor: Bruno Schmidt, Tampa, FL (US)

Correspondence Address: Stanley M. Miller, P.A., Suite 201, 748 Broadway, Dunedin, FL, 34698, US

(21) Appl. No.: 10/162,452

(22) Filed: Jun. 5, 2002

(51) Int. Cl. G21F 5/015

(52) U.S. Cl. 250/506.1

(57) ABSTRACT

A radioactive vial is shielded within a cylindrical vial guard having a central throughbore for receiving the vial. A nuclear pharmacist opens a bottom end of the vial guard and transfers the vial from a shielded shipping container into the throughbore. When the vial is introduced into the throughbore, a septum formed in the vial faces down. The pharmacist closes the bottom end of the vial guard, inverts and opens the top end to expose the septum. A syringe barrel is locked into a throughbore formed in a syringe shield that includes a lead liner. The needle at the leading end of the barrel penetrates the septum and radioactive liquid is withdrawn from the vial into the barrel. The vial guard and syringe shield protect the pharmacist from radiation exposure during the vial opening process.

### BACKGROUND OF THE INVENTION

1. Field of the Invention

This invention relates, generally, to means for handling radiation therapy drugs. More specifically, it relates to a vial guard and a syringe shield that are used with one another to shield a nuclear pharmacist from beta radiation during handling of radioactive vials.

2. Description of the Prior Art

Radioactive Yttrium is a radiation therapy drug in liquid form that is commonly packaged in a vial having a bottle-like shape. When delivered to a nuclear pharmacist, the vial is housed within a plastic tube and the plastic tube is shielded within a lead pig. The nuclear pharmacist removes the vial from the pig and employs a syringe to puncture a septum formed in the vial. The liquid is withdrawn into the barrel of the syringe for mixing and dosing. Accordingly, the syringe must also be shielded.

The current techniques for shielding the vial after it has been removed from the pig and for shielding the syringe after entry of the radioactive liquid thereinto are inadequate to fully protect the pharmacist.

In view of the prior art taken as a whole at the time the present invention was made, it was not obvious to those of ordinary skill in this art how the needed protection could be provided.

### SUMMARY OF THE INVENTION

The long-standing but heretofore unfulfilled need for a system that protects nuclear pharmacists from radiation during vial removal from a pig and during mixing and dosing of radioactive liquid in a syringe is now met by a new, useful, and non-obvious vial guard and syringe shield that are used in conjunction with one another.

The novel vial guard includes a main housing having a longitudinal axis of symmetry. A longitudinally-extending throughbore is formed in the main housing. The throughbore shares a common longitudinal axis of symmetry with the cylindrical main housing. The throughbore is adapted to receive a vial that contains a radioactive liquid. A top closure means closes a top end of the throughbore and a bottom closure means closes a bottom end thereof. The main housing, top closure means, and bottom closure means are preferably made of a transparent plastic material that shields against radiation. The material has a thickness sufficient to adequately prevent travel of radiation therethrough when the radioactive vial is positioned within the throughbore.

The vial guard, top closure means, and bottom closure means collectively form a cylindrical vial guard when the top closure means and the bottom closure means are in closed relation to the throughbore. The top closure means is swivelly mounted to a top wall of the main housing and the bottom closure means is swivelly mounted to a bottom wall of the main housing.

A novel syringe shield is adapted for use with the novel vial guard. Together, the vial guard and syringe shield protect a nuclear pharmacist from radiation during a procedure for opening the vial. The syringe shield includes an outer tube, a center tube, and an inner tube. A thin lead radiation shield having a generally “C” shaped configuration is adhered to the exterior of the center tube. A radial bore is formed in all three tubes and said radial bore is internally threaded in the center tube. A thumbscrew is disposed in a collective radial bore when all three tubes are rotated such that the respective radial bores are in radial alignment with one another. A distal end of the thumbscrew extends into a hollow interior of the inner tube when the thumbscrew is fully advanced. The hollow interior of the inner tube is adapted to slidingly receive a barrel of a syringe. The barrel is locked into a preselected position when the thumbscrew is fully advanced. The inner tube is used with syringes having barrels of small diameter and is not used with syringes having barrels of larger diameter.

The pharmacist transfers the vial from a shielded shipping container by inverting the vial guard so that its top end is supporting it and its bottom end is up. The bottom closure means of the vial guard is then opened and the vial is inserted into the vial guard with the septum end leading. The bottom closure means is then closed and the vial guard is re-inverted so that the top end is again up and the vial guard is supported by its bottom end. The septum formed in the vial is now facing upwardly. The barrel of a syringe is then locked into the syringe shield, the top closure means is opened, and the needle of the syringe pierces the septum of the vial. Withdrawal of the syringe plunger pulls the radioactive liquid into the shielded barrel. Mixing and dosing are performed while the radioactive liquid is in the barrel.

In this way, the vial guard and syringe shield work with one another to protect the handler of the vial.

An important object of this invention is to significantly advance the art of nuclear pharmacy by providing a vial guard that protects a nuclear pharmacist from radiation when a vial containing a radioactive material is removed from a shipping container.

Another object is to protect the pharmacist during the withdrawal of a radioactive material from a vial into the barrel of a syringe and during mixing and dosing of the material within said barrel.

The invention accordingly comprises the features of construction, combination of elements, and arrangement of parts that will be exemplified in the description set forth hereinafter, and the scope of the invention will be set forth in the claims.

### BRIEF DESCRIPTION OF THE DRAWINGS

For a fuller understanding of the nature and objects of the invention, reference is made to the following detailed description, taken in connection with the accompanying drawings, in which:

FIG. 1 is a perspective view of a preferred embodiment of the novel vial guard depicting the top and bottom closure means in their respective closed positions;

FIG. 1A is a perspective view like FIG. 1 but with the top and bottom closure means in their respective open positions;

FIG. 1B is a perspective view of a vial of the type that holds a radioactive radiation therapy drug in liquid form;

FIG. 2 is a perspective view of the novel syringe shield of this invention;

FIG. 2A is an exploded view of said syringe shield;

FIG. 3 is an exploded perspective view depicting the syringe shield and vial guard in alignment with one another; and

FIG. 3A is a perspective view depicting the syringe shield and vial guard in direct contact with one another.

### DETAILED DESCRIPTION OF THE PREFERRED EMBODIMENT

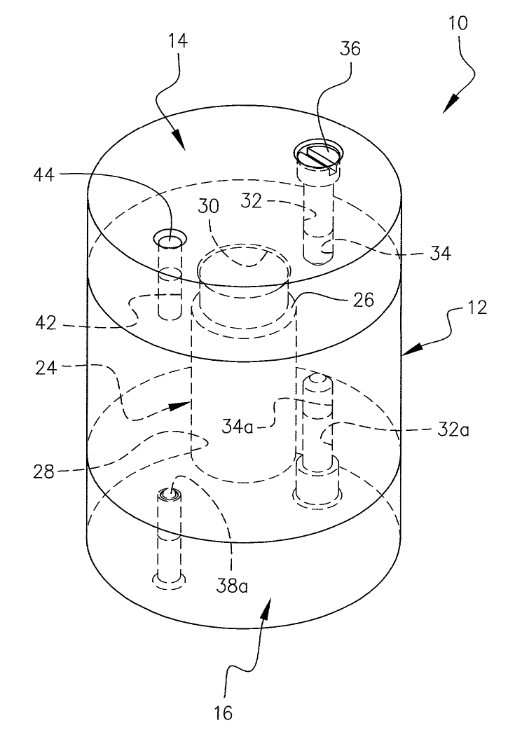

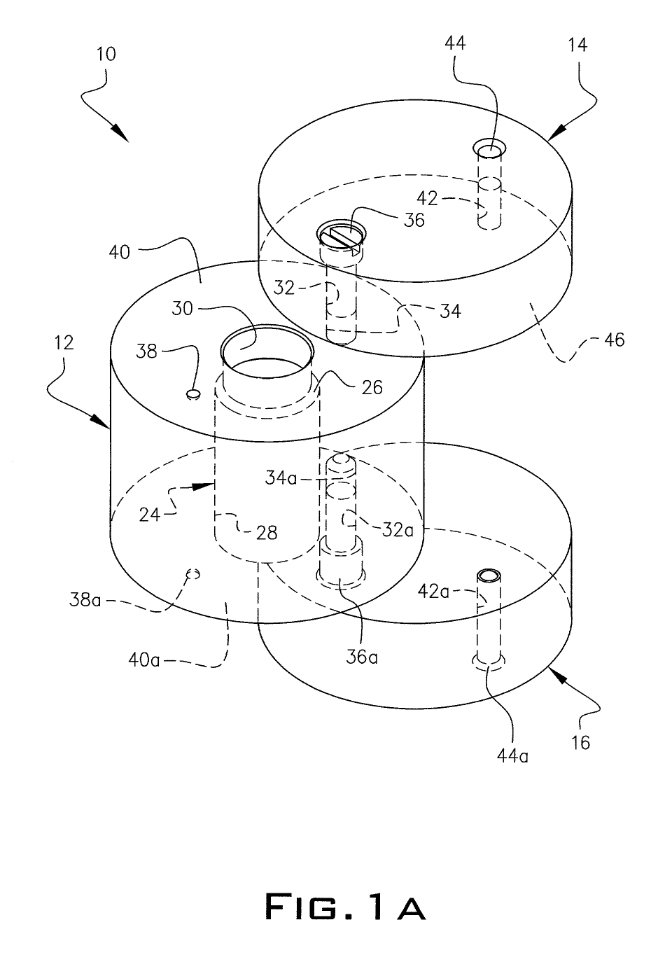

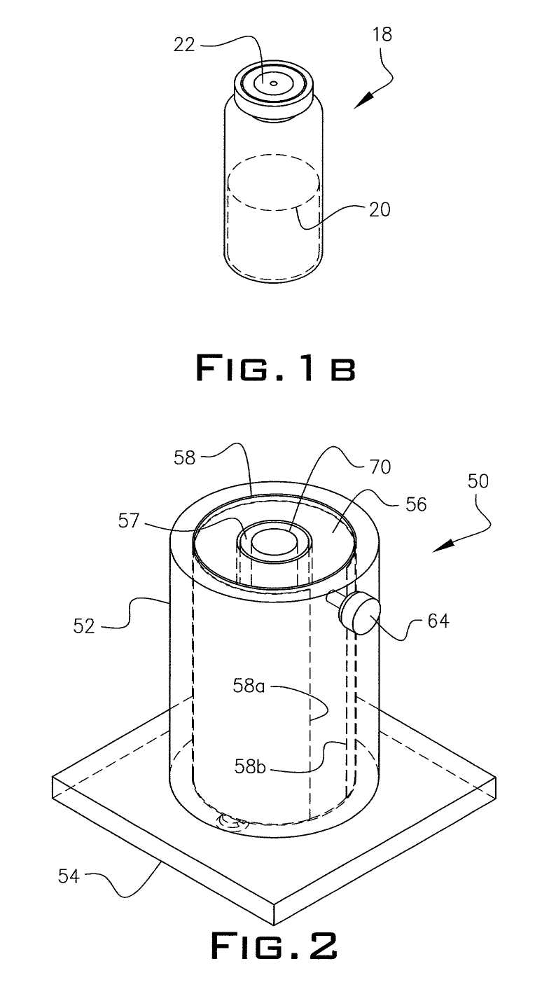

Referring now to FIGS. 1 and 1A, it will there be seen that an illustrative embodiment of the novel vial guard is denoted as a whole by the reference numeral 10. Vial guard 10 has three primary parts: a main housing 12, a top closure means 14, and a bottom closure means 16. Each of these three primary parts is formed of a plastic that is sufficiently thick to provide significant beta radiation shielding. Proper use of guard vial 10, as disclosed herein, minimizes exposure to beta radiation. In a preferred embodiment, the plastic is a polycarbonate but other suitable materials may be used as well. Vial guard 10 is preferably formed of clear materials to facilitate visual verification of a liquid extraction process disclosed hereinafter.

In the illustrated, preferred embodiment, vial guard 10 is of solid cylindrical construction. Other geometrical shapes are within the scope of this invention, but the preferred cylindrical shape minimizes materials while maximizing the distance between a radioactive vial housed by vial guard 10 and the nuclear pharmacist who is the most likely handler of the vial guard.

A typical radioactive vial of the type housed within vial guard 10 is denoted in FIG. 1B by the reference numeral 18. Yttrium 90, a radioactive liquid, is contained within a hollow interior of vial 18 and is denoted 20. A septum 22 at the top or leading end of vial 18 is pierced at its center with a syringe in a manner hereinafter disclosed to extract the Yttrium 90 from vial 18. Other vials may hold radiation therapy drugs other than Yttrium and such other vials are within the scope of this invention.

The shipping container for vial 18 is typically a lead-lined shipping container known as a pig. Vial 18 is positioned in a plastic tube that is in turn housed within the pig.

Returning now to FIGS. 1 and 1A, it will there be observed that a central throughbore 24 is formed in main body 12 to accommodate vial 18. Central throughbore 24 has a longitudinal axis of symmetry that is coincident with the longitudinal axis of symmetry of vial guard 10. A diameter-reducing step 26 is formed near a first end of bore 24 and divides said bore into a first part 28 having a diameter greater than that of second part 30. First part 28 receives the main body of vial 18 and reduced-diameter second part 28 receives the neck thereof. Septum 22 is positioned at the leading end of the neck.

Top closure means 14 is swivel-mounted to main housing 12. More particularly, a countersunk throughbore 32 is formed in top closure means 14 near a peripheral edge thereof and a uniform diameter blind bore 34 is formed in main housing 12 in longitudinal alignment therewith. A socket head shoulder screw 36 or other suitable pivot means is positioned within said bores 32, 34 and serves as a pivot about which top closure means 14 swivels. Uniform diameter bore 34 is preferably internally threaded to engage the external threads of screw 36.

As depicted in FIG. 1A, top closure means 14 is disposed in its fully swiveled, fully open position. However, when top closure means 14 is closed, and when bottom closure means 16 is in its fully open position, vial 18 may be removed from the pig and inserted into central throughbore 24 with septum 22 in a leading position so that it faces bottom wall 46 of top closure means 14. Bottom closure means 16 is then closed, top closure means 14 is opened, and the radioactive material in the vial is removed therefrom in a manner hereinafter described.

Dimple 38 is formed in top wall 40 of main housing 12, near a peripheral edge thereof. It serves to align and lock top closure means 14 into its fully closed position. More particularly, an internally threaded throughbore 42 is formed in top closure means 14 in diametrically spaced apart relation to countersunk bore 32. An externally threaded ball plunger 44 is mounted within bore 42 such that a distal end thereof extends just slightly beyond the plane of bottom wall 46 of top closure means 14. The distal end of ball plunger 44 is formed of a hard but resilient and flexible plastic that is compressed when it encounters top wall 40 as closure means 14 is swiveled about screw 36. When cylindrical top closure means 14 is fully aligned with cylindrical main housing 12, said distal end enters into dimple 38 under its inherent bias and holds said top closure means 14 in its fully closed position. A user can hear and feel the entry of the distal end of ball plunger 44 into dimple 38. Dimple 38 is shallow so that top closure means 14 is easily swiveled back to its open position as needed.

The construction of bottom closure means 16 and its swiveling and locking means is like that of top closure means 14. More particularly, as depicted in FIGS. 1 and 1A, a countersunk throughbore 32a is formed in bottom closure means 16 near a peripheral edge thereof and a uniform diameter blind bore 34a is formed in main housing 12 in longitudinal alignment therewith. A socket head shoulder screw 36a or other suitable pivot means is positioned within said bores 32a, 34a and serves as a pivot about which bottom closure means 16 swivels. Uniform diameter bore 34a is preferably internally threaded to engage the external threads of screw 36a.

Dimple 38a is formed in bottom wall 40a of main housing 12, near a peripheral edge thereof. It serves to align and lock bottom closure means 16 into its fully closed position. More particularly, an internally threaded throughbore 42a is formed in bottom closure means 16 in diametrically spaced apart relation to countersunk bore 32a. An externally threaded ball plunger 44a is mounted within bore 42a such that a distal end thereof extends just slightly beyond the plane of bottom wall 46a of bottom closure means 16. The distal end of ball plunger 44a is formed of a hard but resilient and flexible plastic that is compressed when it encounters bottom wall 40a as bottom closure means 16 is swiveled about screw 36a. When cylindrical bottom closure means 16 is fully aligned with cylindrical main housing 12, said distal end enters into dimple 38a under its inherent bias and holds said bottom closure means 16 in its fully closed position. A user can hear and feel the entry of the distal end of ball plunger 44a into dimple 38a. Dimple 38a is shallow so that bottom closure means 16 is easily swiveled back to its open position as needed.

When vial 18 is inserted into center throughbore 24, septum 22 thereof faces bottom wall 46 of top closure means 14 as aforesaid. To access septum 22, top closure means 14 is fully opened and a syringe is used to puncture septum 22 at its center and to withdraw the radioactive liquid therefrom. If a nuclear pharmacist were to draw the radioactive liquid 20 in vial 18 into the barrel of an unshielded syringe, the benefits of vial guard 10 would be lost because the pharmacist would be exposed to radiation emitting from the barrel of said syringe.

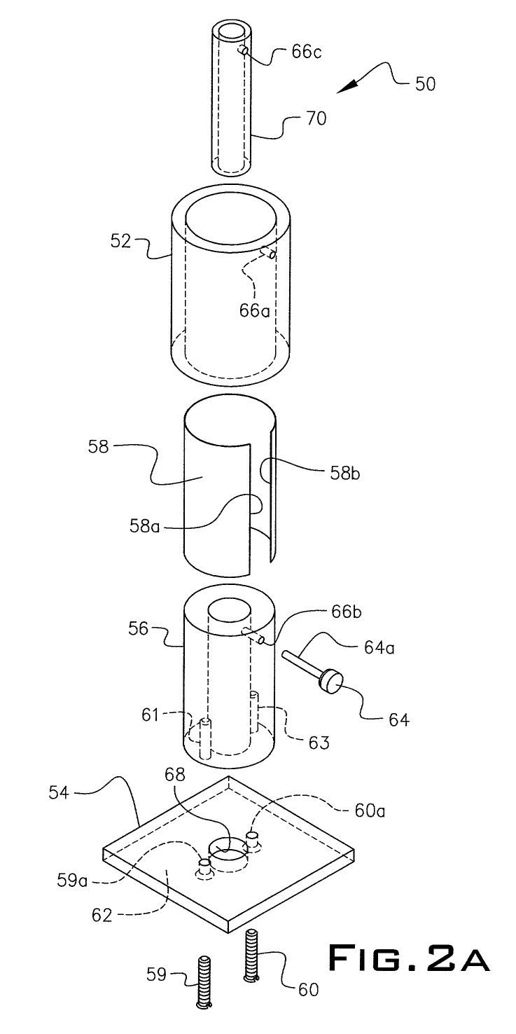

Accordingly, syringe shield 50, depicted in FIGS. 2 and 2A, is provided so that a nuclear pharmacist may draw radioactive liquid 20 from vial 18 while vial 18 remains within vial guard 10.

Syringe shield 50 includes a clear plastic outer tube 52. The nuclear pharmacist grips outer tube 52 when syringe shield 50 is in use.

A square guard means 54 of planar configuration is secured to a proximal end of syringe shield 50 in normal relation to a longitudinal axis of symmetry thereof. It provides enhanced shielding from radiation.

A center tube 56 is positioned within the hollow interior of outer tube 52. In a preferred embodiment, it has a radial thickness equal to or greater than the radial thickness of the walls of outer tube 52, as indicated in FIGS. 2 and 2A.

Radiation shield 58 is adhered to an exterior wall of center tube 56. It has a “C” shape as best indicated in FIG. 2A. A longitudinally-extending space between ends 58a, 58b enables the nuclear pharmacist to observe the withdrawal of radioactive liquid 20 from vial 18 when the invention is used in a manner hereinafter described.

A pair of nylon flat head screws denoted 59 and 60 secure square guard 54 to the proximal end of center tube 56. Outer wall 62 of square guard 54 is countersunk at 59a, 60a so that the respective heads of screws 59 and 60 are recessed with respect to said outer wall when said screws are fully tightened. Center tube 56 is bored and internally threaded as at 61, 63 to receive said screws 59, 60, respectively.

A radially disposed thumbscrew 64 is screw-threadedly engaged with radial bore 66a formed in outer tube 52 and internally threaded radial bore 66b in center tube 56. When manually advanced, distal end 64a of thumbscrew 64 extends into the hollow interior of center tube 56 to act as a set screw locking means for a syringe, not shown, positioned within said hollow interior. More particularly, the hollow interior of center tube 56 has a diameter sufficient to receive a five (5) or ten (10) cc syringe therein. Square guard 54 is centrally apertured as at 68, and the diameter of said aperture is substantially equal to the diameter of the hollow interior of center tube 56. Said diameter is sufficient to receive said five (5) or ten (10) cc syringe therethrough. When the barrel of a syringe of that size is inserted from the thumbscrew end of main body 52 into the hollow interior of center tube 56, advancing thumbscrew 64 locks said barrel (not shown) into position. The needle of the syringe extends beyond the plane of square guard 54.

A nuclear pharmacist uses syringe shield 50 by inserting the barrel of a five (5) or ten (10) cc syringe into the hollow interior of center tube 56 from the thumbscrew end thereof as aforesaid and advances thumbscrew 64 when the barrel is fully inserted. The barrel is now fully shielded by center tube 56, lead radiation shield 58, and by outer tube 52. Top closure means 14 of vial guard 10 is opened to expose septum 22 of vial 18. The nuclear pharmacist holds outer tube 52 of syringe shield 50 and guides the needle into central bore 24 of vial guard main housing 12. The needle is inserted through septum 22 and radioactive liquid 20 is pulled into the barrel of the syringe by retracting the plunger of said syringe. Mixing and dosing procedures, compounding, or other work is performed on the radioactive liquid while it is in the barrel of the syringe.

The longitudinally-extending space between lead radiation shield walls 58a, 58b permits the nuclear pharmacist to observe the withdrawal of liquid 20 into the barrel of the syringe. A white backing 57 (FIG. 2) is placed in overlying relation to the inner cylindrical wall of center tube 56 in diametrically opposed relation to the longitudinally-extending space to enhance visibility. The longitudinal extent of white backing 57 is substantially co-extent with the longitudinally-extending space.

After radioactive liquid 20 has been withdrawn from vial 18, top closure means 14 is closed if vial guard 10 is to be used as a temporary storage means for the empty vial. In most cases, the empty vial is transferred from vial guard 10 to the pig within which it arrived. This is accomplished by holding vial guard 10 so that vial 18 slides into said pig under the influence of gravity.

Syringe shield 50 as just described may be employed to protect a nuclear pharmacist from beta radiation when a five (5) or ten (10) cc syringe is used.

Inner tube 70 (FIGS. 2 and 2A) is slidingly inserted into the hollow interior of center tube 56 when a one (1) or three (3) cc syringe is to be used. Inner tube 70 reduces the diameter of said hollow interior and provides further radiation shielding when such a syringe is to be used. Radial bore 66c is formed in said inner tube and receives the distal end of thumbscrew 64 when said thumbscrew 64 is sufficiently advanced. Said thumbscrew thus holds inner tube 70 against movement in the hollow interior of center tube 56. Moreover, when a one (1) or three (3) cc syringe has been positioned within the hollow interior of said inner tube, a further advance of thumbscrew 64 causes it to bear against the barrel of said syringe, thereby acting as a set screw to lock said barrel into position relative to the hollow interior of said inner tube. The one (1) or three (3) cc syringe is then used in the same way as the five (5) or ten (10) cc syringe.

When inner tube 70 is removed, syringe shield 50 may be used as a vial guard for a two (2) ml vial. The vial is dropped septum-side first into the square guard 54 end of syringe shield 50 so that the septum rests on thumbscrew 64. By slowly backing off the screw, the septum is exposed as the septum falls to where the screw engages a shoulder of the vial. The screw is then locked down on the vial with the septum exposed.

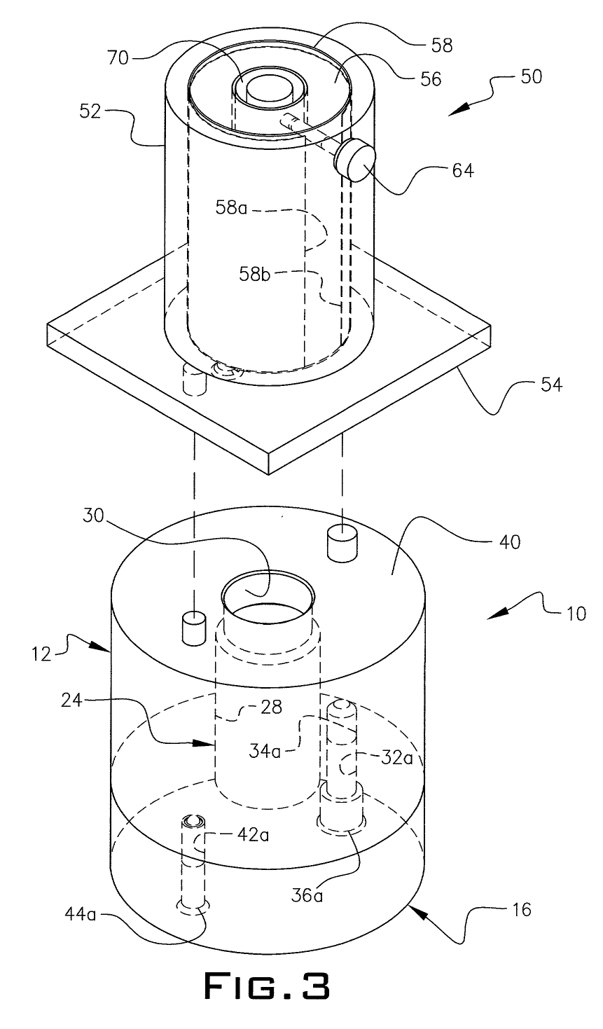

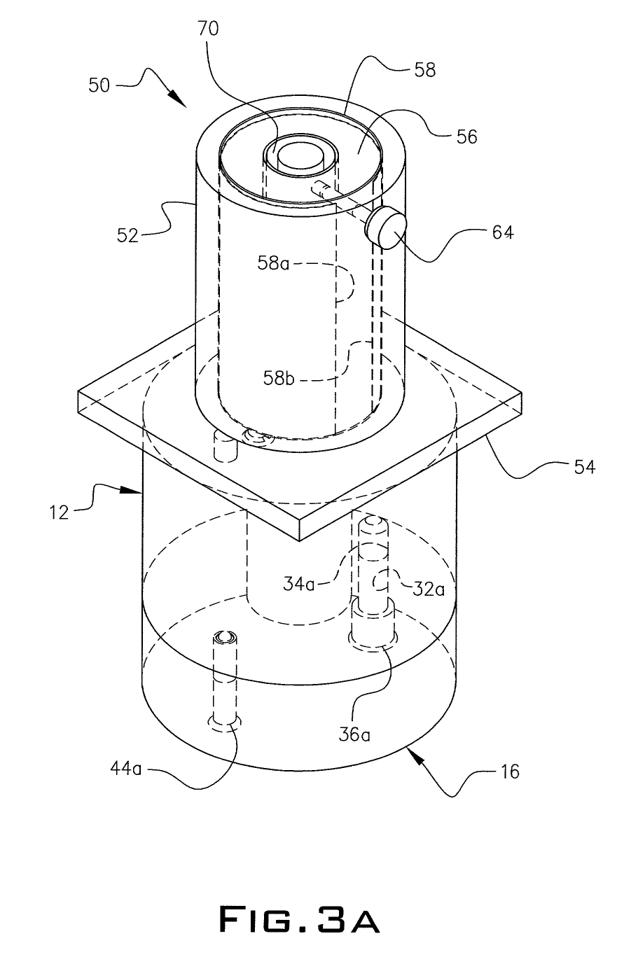

In the embodiment of FIGS. 3 and 3A, top closure means 14 is removed from vial guard 10 so that square guard means 54 directly abuts top wall 40 of main body 12. When said parts abut one another, as depicted in FIG. 3A, the needle (not shown) that projects beyond the plane of square guard means 54 extends through septum 22 of vial 18 and withdrawal of a plunger as mentioned above draws radioactive liquid 20 into the barrel of said undepicted syringe. Set screw 64 holds said barrel in place as aforesaid. In this way, vial guard 10 and syringe shield 50 work together to protect the nuclear pharmacist at each step of the process.

Novel vial guard 10 and novel syringe shield 50 thus cooperate with one another to enable a nuclear pharmacist to handle a radioactive vial and to extract radioactive liquid from the vial into the barrel of a syringe without being exposed to beta radiation. This protects the health of the nuclear pharmacist and ultimately the health of the patients served by the nuclear pharmacist.

It will thus be seen that the objects set forth above, and those made apparent from the preceding description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A vial guard, comprising:
a cylindrical main housing having a longitudinal axis of symmetry;
a longitudinally-extending central throughbore formed in said cylindrical main housing, said central throughbore sharing a common longitudinal axis of symmetry with said cylindrical main housing;
said central throughbore adapted to receive a radioactive vial therewithin;
a top closure means for closing a top end of said central throughbore;
a bottom closure means for closing a bottom end of said central throughbore;
said cylindrical main housing, said top closure means, and said bottom closure means each being made of a material that shields against radiation and each having a thickness sufficient to adequately prevent travel of radiation therethrough when said radioactive vial is positioned within said central throughbore.

2. The vial guard of claim 1, wherein said vial guard, said top closure means, and said bottom closure means collectively form a cylindrical vial guard when said top closure means and said bottom closure means are in closed relation to said central throughbore.

3. The vial guard of claim 1, wherein said top closure means is swivelly mounted to a top wall of said main housing.

4. The vial guard of claim 1, wherein said bottom closure means is swivelly mounted to a bottom wall of said main housing.

5. The vial guard of claim 3, further comprising:
a throughbore formed in said top closure means near a peripheral edge thereof;
a uniform diameter blind bore formed in said top wall of said main housing in longitudinal alignment with said throughbore; and
a pivot means positioned within said throughbore and said blind bore.

6. The vial guard of claim 4, further comprising:
a throughbore formed in said bottom closure means near a peripheral edge thereof;
a uniform diameter blind bore formed in a bottom wall of said main housing in longitudinal alignment with said throughbore; and
a pivot means positioned within said throughbore and said blind bore.

7. The vial guard of claim 5, further comprising:
a dimple formed in said top wall of said main housing, near a peripheral edge thereof;
an internally threaded throughbore formed in said top closure means in diametrically spaced apart relation to said pivot means;
an externally threaded ball plunger mounted within said internally threaded throughbore such that a distal end thereof extends just slightly beyond the plane of a bottom wall of said top closure means;
said ball plunger having a distal end formed of a hard but resilient and flexible plastic that is compressed when it encounters said top wall as said top closure means is swiveled about said pivot means;
said distal end of said ball plunger entering into said dimple under its inherent bias and holding said top closure means in its fully closed position when said top closure means is fully aligned with said cylindrical main housing.

8. The vial guard of claim 6, further comprising:
a dimple formed in said bottom wall of said main housing, near a peripheral edge thereof;
an internally threaded throughbore formed in said bottom closure means in diametrically spaced apart relation to said pivot means;
an externally threaded ball plunger mounted within said internally threaded throughbore such that a distal end thereof extends just slightly beyond the plane of a bottom wall of said bottom closure means;
said ball plunger having a distal end formed of a hard but resilient and flexible plastic that is compressed when it encounters said bottom wall as said bottom closure means is swiveled about said pivot means;
said distal end of said ball plunger entering into said dimple under its inherent bias and holding said bottom closure means in its fully closed position when said bottom closure means is fully aligned with said cylindrical main housing.

9. The vial guard of claim 1, wherein said material is a transparent plastic.

10. The vial guard of claim 9, wherein said material is a polycarbonate.

11. The vial guard of claim 1, wherein said central throughbore has a reduced diameter near a top end of said main housing, and wherein said vial has a bottle-shape, said reduced diameter accommodating a neck of said bottle-shaped vial.

12. A syringe shield, comprising:
an outer tube having a radial bore formed therein;
a center tube disposed in a hollow interior of said outer tube and having a radial bore formed therein;
a lead radiation shield having a generally “C” shaped configuration, said lead radiation shield overlying an exterior wall of said center tube;
said outer tube and said center tube being rotationally aligned with one another so that their respective radial bores are in radial alignment with one another, thereby forming a collective radial bore;
a thumbscrew disposed in engaging relation to said collective radial bore so that a distal end of said thumbscrew extends into a hollow interior of said center tube when said thumbscrew is advanced;
said hollow interior of said center tube adapted to slidingly receive a barrel of a syringe;
said barrel of said syringe being locked into a preselected position when said thumbscrew is advanced;
whereby beta radiation emitted by liquid radioactive material is shielded by said outer tube, said center tube, and said lead radiation shield when said liquid radioactive material is drawn from a vial into said barrel of said syringe.

13. The syringe shield of claim 12, wherein said “C” shape of said lead radiation shield forms a longitudinally-extending space that extends the length of said lead radiation shield.

14. The syringe shield of claim 13, further comprising a light-in-color backing positioned in overlying relation to an interior wall of said center tube in registration with said longitudinally-extending space to enhance viewability when radioactive liquid is pulled into a syringe barrel.

15. The syringe shield of claim 13, further comprising a square guard secured to a distal end of said center tube, said square guard of square, planar configuration and being disposed normal to the longitudinal axis of symmetry of said syringe shield to provide further radiation shielding.

16. The syringe shield of claim 15, further comprising a pair of screws for screw threadedly engaging said square guard to said distal end of said center tube.

17. The syringe shield of claim 12, further comprising an inner tube disposed within a hollow interior of said center tube.

18. The syringe shield of claim 17, further comprising a radial bore formed in said inner tube, said radial bore being alignable with the collective radial bore formed in said outer tube and said center tube so that said thumbscrew may extend through said collective radial bore and said radial bore formed in said inner tube such that said distal end of said thumbscrew extends into a hollow interior of said inner tube when said thumbscrew is advanced, said inner tube serving as an adaptor that enables said syringe shield to accommodate a syringe having a barrel of reduced diameter relative to a barrel of a syringe accommodated by the hollow interior of said center tube, and said inner tube providing increased radiation shielding for said syringe having a barrel of reduced diameter.

19. A combination vial guard and syringe shield, comprising:
said vial guard having a cylindrical main housing having a longitudinal axis of symmetry;
a longitudinally-extending central throughbore formed in said cylindrical main housing, said central throughbore sharing a common longitudinal axis of symmetry with said cylindrical main housing;
said central throughbore adapted to receive a vial containing a radioactive liquid fluid therewithin;
a bottom closure means for closing a bottom end of said central throughbore;
said main housing and said bottom closure means being made of a material that shields against radiation and having a thickness sufficient to adequately prevent travel of radiation therethrough when said vial is positioned within said central throughbore;
said vial guard and said bottom closure means collectively forming a cylindrical vial guard when said bottom closure means is in closed relation to said central throughbore;
said bottom closure means being swivelly mounted to a bottom wall of said main housing;
said central throughbore having a reduced diameter near a top end of said main housing, and said vial having a bottle-shape, said reduced diameter accommodating a neck of said bottle-shaped vial;
said syringe shield including an outer tube having a radial bore formed therein;
said syringe shield having a center tube disposed in a hollow interior of said outer tube and having a radial bore formed in said center tube;
a lead radiation shield having a generally “C” shaped configuration, said lead radiation shield overlying an exterior wall of said center tube;
said outer tube and said center tube being rotationally aligned with one another so that their respective radial bores are in radial alignment with one another, thereby forming a collective radial bore;
a thumbscrew disposed in engaging relation to said collective radial bore so that a distal end of said thumbscrew extends into a hollow interior of said center tube when said thumbscrew is advanced;
said hollow interior of said center tube adapted to slidingly receive a barrel of a syringe;
said barrel of said syringe being locked into a preselected position when said thumbscrew is advanced;
a square guard secured to a distal end of said center tube, said square guard of square, planar configuration and being disposed normal to the longitudinal axis of symmetry of said syringe shield to provide further radiation shielding;
said square guard disposed in abutting relation to a top wall of said main housing of said vial guard and said central throughbore of said vial guard being in axial alignment with said hollow interior of said center tube of said syringe shield;
said main housing of said vial guard and said outer tube, said lead radiation shield, and said center tube of said syringe shield cooperating with one another to shield a user of said combination vial guard and syringe shield from radiation when said vial is positioned within said central throughbore of said vial guard and when said radioactive liquid fluid within said vial is drawn into a barrel of a syringe adapted to be positioned in said hollow interior of said center tube of said syringe shield whereby a needle of said syringe extends from said syringe barrel and into said vial so that withdrawing a plunger of said syringe draws said radioactive liquid fluid into said barrel of said syringe.
